(19) United States
(12) Patent Application Publication
(10) Pub. No.: US 2012/0211258 A1
(43) Pub. Date: Aug. 23, 2012

(54) POLYAMIDE-IMIDE RESIN INSULATING COATING MATERIAL AND INSULATED WIRE USING THE SAME

(75) Inventors: Shuta NABESHIMA, Hitachi (JP); Yuki HONDA, Hitachi (JP); Takami USHIWATA, Hitachi (JP); Tomiya ABE, Hitachi (JP); Hideyuki KIKUCHI, Hitachi (JP)

(73) Assignee: HITACHI CABLE, LTD., Tokyo (JP)

(21) Appl. No.: 13/353,646

(22) Filed: Jan. 19, 2012

(30) Foreign Application Priority Data
Feb. 18, 2011 (JP) 2011-033124

(51) Int. Cl. H01B 3/30; C09D 179/08

(52) U.S. Cl. 174/110 SR; 524/589

(57) ABSTRACT

A polyamide-imide resin insulating coating material includes a polyamide-imide resin produced by reacting an aromatic diisocyanate component with a composition obtained by a synthesis reaction of a diamine component with an acid component that includes an aromatic tricarboxylic acid anhydride component (A) and an aromatic tetracarboxylic dianhydride component (B). The aromatic tetracarboxylic dianhydride component (B) includes an aromatic tetracarboxylic dianhydride component (B-1) having not less than four aromatic rings.

The present application is based on Japanese patent application No. 2011-033124 filed on Feb. 18, 2011, the entire contents of which are incorporated herein by reference.

### BACKGROUND OF THE INVENTION

1. Field of the Invention

The invention relates to a polyamide-imide resin insulating coating material and, in particular, a polyamide-imide resin insulating coating material that can offer a film with a high partial discharge inception voltage, and an insulated wire using the polyamide-imide resin insulating coating material.

2. Description of the Related Art

In general, an insulated wire (or enameled wire) is widely used as a coil for electrical equipments such as rotating electrical machine or electric transformer. In order to meet the needs of motor performance such as downsizing, weight reduction and high heat resistance, a polyamide-imide enameled wire having excellent heat resistance as well as mechanical characteristics to withstand severe conditions of coil forming is vital as such an enameled wire used for a coil.

Meanwhile, electrical equipments such as rotating electrical machine or electric transformer have been driven by inverter control in recent years, and the inverter control may cause high inverter surge voltage in such an electrical equipment using inverter control. When an inverter surge voltage is generated in an electrical equipment, partial discharge occurs in an insulated wire constituting a coil of the electrical equipment due to the inverter surge voltage, which may deteriorate/damage an insulating film.

An insulated wire is known in which a polyamide-imide resin insulating coating material obtained by reacting a diisocyanate component with a resin composition formed by reacting a diamine component having not less than three rings with an acid component is applied and baked on a conductor to form an insulating film so that deterioration of an insulating film due to partial discharge caused by such an inverter surge voltage is prevented (see JP-A-2009-161683). In JP-A-2009-161683, a partial discharge inception voltage is increased by forming an insulating film using the insulating coating material, thereby preventing partial discharge from occurring in an insulated wire.

### SUMMARY OF THE INVENTION

At present, the usage environment of insulated wires has been harsher than before according as the reliability and performance of motors is improved, so that a higher partial discharge inception voltage than before is required.

Since the amount of partial discharge occurred in a motor varies due to, e.g., variation in environmental factors (e.g., atmospheric pressure) of where an electrical equipment is placed, partial discharge more than the previously expected amount may occur in accordance with expansion in usage of electrical equipments. In this case, the amount of partial discharge occurred on a surface of an insulating film of an insulated wire in use may increase, which degrades insulation performance of the insulating film. In addition, when a motor is manufactured, occurrence status of partial discharge may vary depending on how an insulating paper is inserted into a status lot.

As described above, the insulating film may be likely to be deteriorated/damaged depending on different usage environments of an insulated wire, and accordingly, a lifetime of the insulated wire is varied. A conventional insulated wire does not have sufficient resistance against such deterioration/damage to an insulating film which is caused by an increase in the amount of partial discharge.

Therefore, it is an object of the invention to provide a polyamide-imide resin insulating coating material that can offer an insulating film with a high partial discharge inception voltage, and an insulated wire using the polyamide-imide resin insulating coating material.

(1) According to one embodiment of the invention, a polyamide-imide resin insulating coating material comprises:

a polyamide-imide resin produced by reacting an aromatic diisocyanate component with a composition obtained by a synthesis reaction of a diamine component with an acid component that includes an aromatic tricarboxylic acid anhydride component (A) and an aromatic tetracarboxylic dianhydride component (B),

wherein the aromatic tetracarboxylic dianhydride component (B) includes an aromatic tetracarboxylic dianhydride component (B-1) having not less than four aromatic rings.

In the above embodiment (1) of the invention, the following modifications and changes can be made.

(i) The aromatic tetracarboxylic dianhydride component (B-1) having not less than four rings is included in the aromatic tetracarboxylic dianhydride component (B) at a molar ratio (B-1)/(B) in a range of 20/100 to 100/100.

(ii) A compounding ratio of the aromatic tricarboxylic acid anhydride component (A) to the aromatic tetracarboxylic dianhydride component (B) in the acid component is (A)/(B)=10/90 to 50/50 when expressed as a molar ratio.

(iii) The aromatic tetracarboxylic dianhydride component (B-1) having not less than four rings comprises 2,2-bis[4-(3,4-dicarboxyphenoxy)phenyl]propane dianhydride.

(iv) The diamine component comprises an aromatic diamine having not less than three rings.

(2) According to another embodiment of the invention, an insulated wire comprises:

an insulating film formed by applying and baking the polyamide-imide resin insulating coating material according to the embodiment (1) directly on a conductor or on an other film on the conductor.

### EFFECTS OF THE INVENTION

According to one embodiment of the invention, a polyamide-imide resin insulating coating material is provided that can offer an insulating film with a high partial discharge inception voltage while securing desired characteristics (e.g., adhesion) of enameled wire, and an insulated wire using the polyamide-imide resin insulating coating material is provided.

### DETAILED DESCRIPTION OF THE PREFERRED EMBODIMENTS

A preferred embodiment of the invention will be described below.

The inventors found that, in a polyamide-imide resin insulating coating material formed by reacting an aromatic diisocyanate component with a composition which is obtained by a synthesis reaction of a diamine component with an acid component including an aromatic tricarboxylic acid anhydride component and an aromatic tetracarboxylic dianhydride component, use of an aromatic tetracarboxylic dianhydride component having not less than four rings (benzene ring) as the aromatic tetracarboxylic dianhydride component effectively lowers dielectric constant of an insulating film to be formed as compared to a conventional art and allows an insulated wire with a high partial discharge inception voltage to be obtained.

That is, the invention is characterized in that, in a polyamide-imide resin insulating coating material formed by reacting an aromatic diisocyanate component with a composition which is obtained by a synthesis reaction of a diamine component with an acid component including an aromatic tricarboxylic acid anhydride component (A) and an aromatic tetracarboxylic dianhydride component (B), the aromatic tetracarboxylic dianhydride component (B) includes an aromatic tetracarboxylic dianhydride component (B-1) having not less than four rings. A compounding ratio of (A) to (B), each component and a synthesis reaction, etc., will be individually explained.

Compounding Ratio

A compounding ratio (molar ratio) of the aromatic tricarboxylic acid anhydride component (A) to the aromatic tetracarboxylic dianhydride component (B) including the aromatic tetracarboxylic dianhydride component (B-1) having not less than four rings as an acid component is not specifically limited as long as (A)/(B) is within a range of 10/90 to 50/50 in view of adhesion.

As for the aromatic tetracarboxylic dianhydride component (B), it is preferable that a molar ratio of the aromatic tetracarboxylic dianhydride component (B-1) having not less than four rings to the aromatic tetracarboxylic dianhydride component (B) be “(B-1)/(B)=20/100 to 100/100”. That is, the aromatic tetracarboxylic dianhydride component (B) preferably includes the aromatic tetracarboxylic dianhydride component (B-1) having not less than four rings at a molar fraction of not less than 20% and not more than 100%.

Acid Component

As an acid component, TMA (trimellitic anhydride) is used as the aromatic tricarboxylic acid anhydride component (A). Although aromatic tricarboxylic acid anhydrides such as benzophenone tricarboxylic acid anhydride can be used, TMA is most preferable in terms of cost.

As for the aromatic tetracarboxylic dianhydride component (B), examples of the aromatic tetracarboxylic dianhydride component (B-1) having not less than four rings can include 2,2-bis[4-(3,4-dicarboxyphenoxy)phenyl]propane dianhydride (BPADA), 3,3′″,4,4′″-p-quaterphenyltetracarboxylic dianhydride and 3,3′″,4,4′″-p-quinquephenyltetracarboxylic dianhydride. It is also possible to use other aromatic tetracarboxylic dianhydrides having not less than four rings. It is preferable to use a monomer having a large weight-average molecular weight (Mw) (e.g., a weight-average molecular weight of not less than 400) as the aromatic tetracarboxylic dianhydride component (B-1) having not less than four rings in order to obtain a high partial discharge inception voltage, and BPADA (represented by the chemical formula I below) is preferable in view of characteristics such as reactivity during synthesis reaction and adhesion or flexibility when formed into an insulating film.

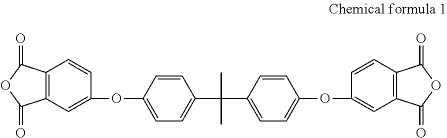

Alternatively, the aromatic tetracarboxylic dianhydride component (B) may include an aromatic tetracarboxylic dianhydride having not less than three rings as an aromatic tetracarboxylic dianhydride component (B-2) other than the aromatic tetracarboxylic dianhydride component (B-1) having not less than four rings. Such a component (B-2) includes, e.g., pyromellitic dianhydride (PMDA), 3,3′,4,4′-benzophenone-tetracarboxylic dianhydride (BTDA), 3,3′,4,4′-diphenyl sulfone-tetracarboxylic dianhydride (DSDA), 4,4′-oxydiphthalic dianhydride (ODPA), 3,3′,4,4′biphenyltetracarboxylic dianhydride (BPDA) and 4,4′-(2,2-hexafluoroisopropylidene)bis(phthalic anhydride) (6FDA), etc. Alternatively, an alicyclic tetracarboxylic dianhydride as the hydrogenated aromatic tetracarboxylic dianhydride may be used together if needed. In this regard, use of aliphatic materials reduces dielectric constant and a high partial discharge inception voltage is expected but heat resistance may be deteriorated, therefore, it is necessary to be careful about a compound ratio or a combination of compositions.

Diamine Component

Examples of diamine component can include, e.g., an aromatic diamine having not less than three rings which is formed of at least one selected from 2,2-bis[4-(4-aminophenoxy)phenyl]propane (BAPP), bis[4-(4-aminophenoxy)phenyl]sulfone (BAPS), bis[4-(4-aminophenoxy)phenyl]ether (BAPE), 4,4′-bis(4-aminophenoxy)biphenyl (BAPB), 1,4-bis(4-aminophenoxy)benzene and 9,9-bis(4-aminophenyl)fluorene (FDA), etc., or isomers thereof, or an aromatic diamine having not more than two aromatic rings which is formed of at least one selected from 1,4-diaminobenzene, 2,4-diaminotoluene, 4,4′-diaminodiphenylmethane, 4,4′-diaminodiphenyl ether (ODA), 2,2′-dimethyl-4,4′-diaminobiphenyl, 2,2′-bis(trifluoromethyl)-4,4′-diaminobiphenyl, 4,4′-diaminobenzophenone, 4,4′-bis (4-aminophenyl)sulfide and 4,4′-diaminodiphenyl sulfone, etc., or isomers thereof. These aromatic diamines can be used alone or in a combination thereof.

It is especially preferable that an aromatic diamine having not less than three rings be used as a diamine component. This is because the total molecular weight of the minimum repeating unit is increased by use of especially aromatic diamine having not less than three rings as a monomer having a large molecular weight (weight-average molecular weight) and an aromatic tetracarboxylic dianhydride component having not less than four rings, and it is thus possible to lower an abundance ratio, in a polymer, of an amide group and an imide group which are polar groups most affecting a rise in the dielectric constant.

In addition, among the aromatic diamine having not less than three rings, an aromatic diamine having an ether bond in a molecule such as 2,2-bis[4-(4-aminophenoxy)phenyl]propane (BAPP), bis[4-(4-aminophenoxy)phenyl]sulfone (BAPS), bis[4-(4-aminophenoxy)phenyl]ether (BAPE), 4,4′-bis(4-aminophenoxy)biphenyl or 1,4-bis(4-aminophenoxy)benzene should be used especially in view of improvements in partial discharge inception voltage and in flexibility.

Aromatic Diisocyanate Component

Examples of aromatic diisocyanate component include an aromatic diisocyanate such as 4,4′-diphenylmethane diisocyanate (MDI), 2,2-bis[4-(4-isocyanatephenoxy)phenyl]propane (BIPP), tolylene diisocyanate, naphthalene diisocyanate, xylylene diisocyanate, biphenyl diisocyanate, diphenyl sulfone diisocyanate and diphenyl ether diisocyanate, and isomers thereof. Alternatively, aliphatic diisocyanates such as hexamethylene diisocyanate, isophorone diisocyanate or dicyclohexylmethane diisocyanate, or alicyclic diisocyanates in which the above exemplified aliphatic diisocyanate is hydrogenated and isomers thereof may be used or combined, if required.

Azeotropic Solvent

It is desirable that a first synthesis reaction for synthetically reacting a diamine component with an acid component be carried out in the presence of an azeotropic solvent in addition to a typical solvent, e.g., N-methyl-2-pyrrolidone (NMP), etc. This is to increase efficiency of the synthesis reaction, such as imidization ratio, by facilitating removal of water associated with the synthesis reaction. Accordingly, when the ultimately obtained polyamide-imide resin insulating coating material is used for forming an insulating film of an insulated wire, etc., it is possible to obtain an insulating film excellent in flexibility with a high partial discharge inception voltage. The azeotropic solvent can include, e.g., xylene, toluene, benzene or ethyl benzene, etc., and xylene is particularly preferable in view of risk/hazardous properties and of effectively taking advantage of the features of the invention.

Synthesis Reaction

A synthesis of the polyamide-imide resin insulating coating material is carried out in two steps, a first synthesis reaction for reacting a diamine component with an acid component and a second synthesis reaction for reacting a composition obtained by the first synthesis reaction with an aromatic diisocyanate component. A reaction catalyst such as amines, imidazoles or imidazolines may be used for the synthesis of the polyamide-imide resin insulating coating material, and in this regard, a reaction catalyst not impairing stability of the coating material is desirable. A sealant such as alcohol may be used when the synthesis reaction is terminated.

Various additive agents such as colorant, dye, inorganic or organic filler, lubricant agent, antioxidant and leveling agent, etc., may be included if needed without impeding the object of the invention.

An insulating film is formed by applying and baking the polyamide-imide resin insulating coating material on a conductor made of copper, etc., or on another film, and it is thereby possible to obtain an insulated wire (enameled wire). It is possible to use a conductor in various shapes such as a round wire or a flat wire.

In addition, a film, etc., having lubricity may be formed on the insulating film formed of the polyamide-imide resin insulating coating material of the invention. Furthermore, a firm for improving adhesion may be provided between the insulating film and the conductor. Alternatively, the firm for improving adhesion may be provided alone.

In sum, according to the invention, a polyamide-imide resin insulating coating material which is excellent in characteristics such as flexibility and adhesion to a conductor and is capable of forming a film of which partial discharge inception voltage is high even with the smaller film thickness than the conventional is obtained by using a diamine component and synthetically reacting the aromatic tricarboxylic acid anhydride component (A) and the aromatic tetracarboxylic dianhydride component (B-1) having not less than four rings with an aromatic diisocyanate component. In addition, use of the aromatic diamine having not less than three rings as a diamine component further increases the total molecular weight of the minimum repeating unit in a polymer chain and lowers an abundance ratio of an amide group and an imide group, and it is thereby possible to further improve the partial discharge inception voltage.

### EXAMPLES

Examples 1 to 7 and Comparative Examples 1 and 2 will be explained.

The polyamide-imide resin insulating coating materials in Examples 1 to 7 and Comparative Examples 1 and 2 were synthesized using an azeotropic solvent, and two steps of synthesis were carried out as follows.

For the first synthesis reaction, an aromatic diamine component, the aromatic tricarboxylic acid anhydride component (A) and the aromatic tetracarboxylic dianhydride component (B) which are shown in Examples 1 to 7 and Comparative Examples 1 and 2, N-methyl-2-pyrrolidone (NMP) as a solvent and xylene as an azeotropic solvent were introduced into a flask provided with a stirrer, a reflux cooling tube, a nitrogen inlet tube and a thermometer, and were subsequently reacted at a stirring speed of 180 rpm and at a system temperature of 180° C. under a nitrogen atmosphere for 4 hours. The synthesis reaction was carried out while water and xylene produced during a dehydration reaction were constantly eliminated from the system. An aromatic diisocyanate component was mixed after cooling down to not more than 90° C. while keeping the nitrogen atmosphere, and a reaction was carried out at a stirring speed of 150 rpm and at a system temperature of 140° C. for 4 hours. A termination reaction was then carried out by mixing a sealant and NMP as a solvent, thereby obtaining a polyamide-imide resin insulating coating material.

Then, the resulting polyamide-imide resin insulating coating material was applied and baked on a 0.8 mm copper conductor, thereby obtaining an insulated wire (enameled wire) having a 0.040 mm-thick insulating film.

Tables 1 and 2 show each component used in Examples 1 to 7 and Comparative Examples 1 and 2, compounding ratios thereof and characteristics, etc., of the obtained enameled wire. In Tables 1 and 2, the aromatic tetracarboxylic dianhydride (B-2) of “Acid component” indicates, among all of aromatic tetracarboxylic dianhydrides, aromatic tetracarboxylic dianhydrides other than the aromatic tetracarboxylic dianhydride (B-1) having not less than four rings. In addition, (B) of “Compounding ratio” indicates the entire aromatic tetracarboxylic dianhydride which is composed of the aromatic tetracarboxylic dianhydride (B-1) having not less than four rings and the aromatic tetracarboxylic dianhydride (B-2).

The characteristics (flexibility, adhesion and partial discharge inception voltage) of the enameled wire were evaluated by the following procedures.

Flexibility Test

A flexibility test was conducted as follows. Firstly, the enameled wire was elongated 30% by a method in accordance with JIS C 3003. Then, the enameled wire elongated 30% was wound around a winding rod having a diameter (nd: 1≦n≦10) of one to ten times the conductor diameter (d) of the enameled wire by a method in accordance with JIS C 3003, and the minimum winding rod diameter (dₘᵢₙ) at which occurrence of cracks on the insulating film is not observed by using an optical microscope was measured. The enameled wires in which the measured minimum winding rod diameter (dₘᵢₙ) without occurrence of cracks on the insulation film is not more than 2d were judged as “Pass”.

Adhesion Test

An adhesion test was conducted as follows. A straight enameled wire was coaxially fixed to two clamps placed at a distance of 250 mm, an insulating film of the sample on two longitudinally parallel sides was removed until reaching the conductor, one of the clamps was subsequently rotated by a method in accordance with JIS C 3003, and the number of rotations (defining 360° as one rotation) at the point that the insulating film was separated was measured. The results in which the number of rotations at the point that the insulating film was separated is not less than 85 was judged as “Pass”.

Measurement of Partial Discharge Inception Voltage

An enameled wire was cut in a length of 500 mm to make a sample of twisted pair enameled wire, and an end processed portion was formed by removing the insulating film to a position 10 mm from the end portion. Using a partial discharge inception voltage test system (DAC-PD-3, manufactured by Soken Electric Co., Ltd.), an electrode was connected to the end processed portion, and then, voltage at which 100 pC of discharge occurs 50 times/second in the twisted pair enameled wire was measured in an atmosphere at 25° C. with humidity of 50% while the voltage of 50 Hz was increased at a rate of 10-30 V/s. The measurement was repeated three times and the average value of the measured voltages was defined as a partial discharge inception voltage.

TABLE 1

| | | | | Example 1 | Example 2 | Example 3 | Example 4 | Example 5 | Example 6 | Example 7 |
|---|---|---|---|---|---|---|---|---|---|---|
| Polyamide- | Diamine | Diamine having not | BAPP | 307.7 | 369.2 | 369.2 | — | — | 307.7 | — |
| imide resin | compo- | less than three rings | (Mw: 410) | (0.75) | (0.9) | (0.9) | | | (0.75) | |
| raw material | nent | | BAPE | — | — | — | 345.6 | — | — | — |
| [g] ([mol] | | | (Mw: 384) | | | | (0.9) | | | |
| in bracket) | | | BAPB | — | — | — | — | 294.4 | — | — |
| | | | (Mw: 368) | | | | | (0.8) | | |
| | | Diamine having not | ODA | — | — | — | — | — | — | 150.0 |
| | | more than two | (Mw: 200) | | | | | | | (0.75) |
| | | aromatic rings | | | | | | | | |
| | Acid | Aromatic tricarboxylic | TMA | 96.1 | 38.4 | 38.4 | 38.4 | 76.8 | 96.1 | 96.1 |
| | compo- | acid anhydride (A) | (Mw: 192.1) | (0.5) | (0.2) | (0.2) | (0.2) | (0.4) | (0.5) | (0.5) |
| | nent | Aromatic | ODPA | — | — | 199.7 | 124.8 | — | — | — |
| | | tetracarboxylic | (Mw: 310) | | | (0.64) | (0.4) | | | |
| | | dianhydride (B-2) | | | | | | | | |
| | | Aromatic | BPADA | 260.0 | 416.1 | 83.2 | 208.0 | 312.1 | 260.0 | 260.0 |
| | | tetracarboxylic | (Mw: 520) | (0.5) | (0.8) | (0.16) | (0.4) | (0.6) | (0.5) | (0.5) |
| | | dianhydride (B-1) | | | | | | | | |
| | | having not less than | | | | | | | | |
| | | four rings | | | | | | | | |
| | Isocyanate | Aromatic diisocyanate | MDI | 62.6 | 25.0 | 25.0 | 25.0 | 50.0 | — | 62.6 |
| | compo- | | (Mw: 250) | (0.25) | (0.1) | (0.1) | (0.1) | (0.2) | | (0.25) |
| | nent | | BIPP | — | — | — | — | — | 115.5 | — |
| | | | (Mw: 462) | | | | | | (0.25) | |

| Compounding | (A)/(B) | | 50/50 | 20/80 | 20/80 | 20/80 | 40/60 | 50/50 | 50/50 |
|---|---|---|---|---|---|---|---|---|---|
| ratio | (B-1)/(B) | | 100/100 | 100/100 | 20/100 | 50/100 | 100/100 | 100/100 | 100/100 |
| Characteristics | Flexibility | 30% elongation | Pass | Pass | Pass | Pass | Pass | Pass | Pass |
| of enameled | Adhesion | Peeling | 96 | 99 | 97 | 93 | 88 | 99 | 92 |
| wire | Partial | Film thickness: 40 μm | 1023 | 1038 | 1014 | 1006 | 1004 | 1045 | 983 |
| | discharge | (at 25° C. in 50% RH) | | | | | | | |
| | inception | | | | | | | | |
| | voltage | | | | | | | | |

BAPP: 2,2-bis[4-(4-aminophenoxy)phenyl]propane,
BAPE: bis[4-(4-aminophenoxy)phenyl] ether,
BAPB: 4,4′-bis(4-aminophenoxy)biphenyl,
ODA: 4,4′-diaminodiphenyl ether,
TMA: trimellitic anhydride,
ODPA: 4,4′-oxydiphthalic dianhydride,
BPADA: 2,2-bis [4-(3,4-dicarboxyphenoxy) phenyl] propane dianhydride,
MDI: 4,4′-diphenylmethane diisocyanate,
BIPP: 2,2-bis[4-(4-isocyanatephenoxy)phenyl]propane

### Example 1

307.7 g portion (0.75 mol) of BAPP as a diamine component was mixed with 96.1 g portion (0.5 mol) of TMA as the aromatic tricarboxylic acid anhydride component (A) and 260.0 g portion (0.5 mol) of BPADA as the aromatic tetracarboxylic dianhydride component (B-1) having not less than four rings constituting the aromatic tetracarboxylic dianhydride component (B) which are acid components, thereby carrying out a first synthesis reaction. Then, 62.6 g portion (0.25 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Example 2

369.2 g portion (0.9 mol) of BAPP as a diamine component was mixed with 38.4 g portion (0.2 mol) of TMA as the aromatic tricarboxylic acid anhydride component (A) and 416.1 g portion (0.8 mol) of BPADA as the aromatic tetracarboxylic dianhydride component (B-1) having not less than four rings constituting the aromatic tetracarboxylic dianhydride component (B) which are acid components, thereby carrying out a first synthesis reaction. Then, 25.0 g portion (0.1 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Example 3

369.2 g portion (0.9 mol) of BAPP as a diamine component was mixed with 38.4 g portion (0.2 mol) of TMA as the aromatic tricarboxylic acid anhydride component (A), 199.7 g portion (0.64 mol) of ODPA as the aromatic tetracarboxylic dianhydride component (B-2) and 83.2 g portion (0.16 mol) of BPADA as the aromatic tetracarboxylic dianhydride component (B-1) having not less than four rings which are acid components, thereby carrying out a first synthesis reaction. Then, 25.0 g portion (0.1 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Example 4

345.6 g portion (0.9 mol) of BAPE as a diamine component was mixed with 38.4 g portion (0.2 mol) of TMA as the aromatic tricarboxylic acid anhydride component (A), 124.8 g portion (0.4 mol) of ODPA as the aromatic tetracarboxylic dianhydride component (B-2) and 208.0 g portion (0.4 mol) of BPADA as the aromatic tetracarboxylic dianhydride component (B-1) having not less than four rings which are acid components, thereby carrying out a first synthesis reaction. Then, 25.0 g portion (0.1 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Example 5

294.4 g portion (0.8 mol) of BAPB as a diamine component was mixed with 76.8 g portion (0.4 mol) of TMA as the aromatic tricarboxylic acid anhydride component (A) and 312.1 g portion (0.6 mol) of BPADA as the aromatic tetracarboxylic dianhydride component (B-1) having not less than four rings constituting the aromatic tetracarboxylic dianhydride component (B) which are acid components, thereby carrying out a first synthesis reaction. Then, 50.0 g portion (0.2 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Example 6

307.7 g portion (0.75 mol) of BAPP as a diamine component was mixed with 96.1 g portion (0.5 mol) of TMA as the aromatic tricarboxylic acid anhydride component (A) and 260.0 g portion (0.5 mol) of BPADA as the aromatic tetracarboxylic dianhydride component (B-1) having not less than four rings constituting the aromatic tetracarboxylic dianhydride component (B) which are acid components, thereby carrying out a first synthesis reaction. Then, 115.5 g portion (0.25 mol) of BIPP was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Example 7

150.0 g portion (0.75 mol) of ODA as a diamine component was mixed with 96.1 g portion (0.5 mol) of TMA as the aromatic tricarboxylic acid anhydride component (A) and 260.0 g portion (0.5 mol) of BPADA as the aromatic tetracarboxylic dianhydride component (B-1) having not less than four rings constituting the aromatic tetracarboxylic dianhydride component (B) which are acid components, thereby carrying out a first synthesis reaction. Then, 62.6 g portion (0.25 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

TABLE 2

| | | | | Comparative | Comparative |
|---|---|---|---|---|---|
| | | | | Example 1 | Example 2 |
| Polyamide-imide resin raw | Diamine | Diamine having not less than three | BAPP | 307.7 | 307.7 |
| material | component | rings | (Mw: 410) | (0.75) | (0.75) |
| [g] ([mol] in bracket) | Acid component | Aromatic tricarboxylic acid | TMA | 96.1 | 96.1 |
| | | anhydride (A) | (Mw: 192.1) | (0.5) | (0.5) |
| | | Aromatic tetracarboxylic | ODPA | 156.0 | — |
| | | dianhydride (B-2) | (Mw: 310) | (0.5) | |
| | | | BTDA | — | 162.0 |
| | | | (Mw: 324) | | (0.5) |
| | | Aromatic tetracarboxylic | BPADA | — | — |
| | | dianhydride (B-1) having not less | (Mw: 520) | | |
| | | than four rings | | | |
| | Isocyanate | Aromatic diisocyanate | MDI | 62.6 | 62.6 |
| | component | | (Mw: 250) | (0.25) | (0.25) |

| Compounding | (A)/(B) | | 50/50 | 50/50 |
|---|---|---|---|---|
| ratio | (B-1)/(B) | | — | — |
| Characteristics | Flexibility | 30% elongation | Pass | Pass |
| of enameled | Adhesion | Peeling | 83 | 81 |
| wire | Partial discharge | Film thickness: 40 μm | 969 | 962 |
| | inception voltage | (at 25° C. in 50% RH) | | |

BAPP: 2,2-bis[4-(4-aminophenoxy)phenyl]propane,
TMA: trimellitic anhydride,
ODPA: 4,4′-oxydiphthalic dianhydride,
BTDA: 3,3′,4,4′-benzophenone-tetracarboxylic dianhydride,
BPADA: 2,2-bis [4-(3,4-dicarboxyphenoxy) phenyl] propane dianhydride,
MDI: 4,4′-diphenylmethane diisocyanate

### Comparative Example 1

307.7 g portion (0.75 mol) of BAPP as a diamine component was mixed with 96.1 g portion (0.5 mol) of TMA as the aromatic tricarboxylic acid anhydride component (A) and 156.0 g portion (0.5 mol) of ODPA as the aromatic tetracarboxylic dianhydride component (B-2) which are acid components, thereby carrying out a first synthesis reaction.

Then, 62.6 g portion (0.25 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

### Comparative Example 2

307.7 g portion (0.75 mol) of BAPP as a diamine component was mixed with 96.1 g portion (0.5 mol) of TMA as the aromatic tricarboxylic acid anhydride component (A) and 162.0 g portion (0.5 mol) of BTDA as the aromatic tetracarboxylic dianhydride component (B-2) which are acid components, thereby carrying out a first synthesis reaction. Then, 62.6 g portion (0.25 mol) of MDI was mixed and reacted. A termination reaction was carried out at the end, thereby obtaining a polyamide-imide resin insulating coating material. Then, the polyamide-imide resin insulating coating material was repeatedly applied and baked on a copper conductor having a diameter of 0.80 mm so as to have a film thickness of 0.040 mm, thereby obtaining an insulated wire.

The partial discharge inception voltage is low in Comparative Examples 1 and 2. Contrary to this, it was confirmed that the partial discharge inception voltage is improved in the polyamide-imide enameled wires in Examples 1 to 7. Especially, it was found that high partial discharge inception voltage of not less than 980 Vp is obtained even though the insulating film is thinner (film thickness of 40 μm) than the conventional art. In addition, the polyamide-imide enameled wires in Examples 1 to 7 have also satisfactory results in adhesion as compared to Comparative Examples 1 and 2.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A polyamide-imide resin insulating coating material, comprising:
a polyamide-imide resin produced by reacting an aromatic diisocyanate component with a composition obtained by a synthesis reaction of a diamine component with an acid component that includes an aromatic tricarboxylic acid anhydride component (A) and an aromatic tetracarboxylic dianhydride component (B),
wherein the aromatic tetracarboxylic dianhydride component (B) includes an aromatic tetracarboxylic dianhydride component (B-1) having not less than four aromatic rings.

2. The polyamide-imide resin insulating coating material according to claim 1, wherein the aromatic tetracarboxylic dianhydride component (B-1) having not less than four rings is included in the aromatic tetracarboxylic dianhydride component (B) at a molar ratio (B-1)/(B) in a range of 20/100 to 100/100.

3. The polyamide-imide resin insulating coating material according to claim 1, wherein a compounding ratio of the aromatic tricarboxylic acid anhydride component (A) to the aromatic tetracarboxylic dianhydride component (B) in the acid component is (A)/(B)=10/90 to 50/50 when expressed as a molar ratio.

4. The polyamide-imide resin insulating coating material according to claim 1, wherein the aromatic tetracarboxylic dianhydride component (B-1) having not less than four rings comprises 2,2-bis[4-(3,4-dicarboxyphenoxy)phenyl]propane dianhydride.

5. The polyamide-imide resin insulating coating material according to claim 1, wherein the diamine component comprises an aromatic diamine having not less than three rings.

6. An insulated wire, comprising:
an insulating film formed by applying and baking the polyamide-imide resin insulating coating material according to claim 1 directly on a conductor or on an other film on the conductor.
